(19) United States
(12) Patent Application Publication
(10) Pub. No.: US 2013/0346344 A1
(43) Pub. Date: Dec. 26, 2013

(54) SYSTEM AND METHOD FOR SELLING REAL ASSET IN ASSOCIATION WITH FINANCIAL PRODUCT

(71) Applicant: Jun Young Lee, Seoul (KR)

(72) Inventor: Jun Young Lee, Seoul (KR)

(73) Assignees: KIA MOTORS CORPORATION, Seoul (KR); HYUNDAI MOTOR COMPANY, Seoul (KR)

(21) Appl. No.: 14/002,832

(22) PCT Filed: Sep. 27, 2011
(86) PCT No.: PCT/KR11/07107

§ 371 Date: Sep. 3, 2013

(30) Foreign Application Priority Data
Mar. 3, 2011 (KR) 10-2011-0018970

(51) Int. Cl. G06Q 40/06

(52) U.S. Cl. CPC G06Q 40/06
USPC 705/36 R

(57) ABSTRACT

Provided is a system for selling a real asset in association with a financial product. An automobile sales server determines investment money as a purchase price of a new car to be purchased by a customer, determines a loss ratio of the investment money based on a value of a junk car to be delivered by the customer, and transmits the determined investment money and the loss ratio along with customer information to a fund subscription server. The fund is redeemed when a loss of the investment money of the customer exceeds a corresponding loss ratio or a predetermined fund operation period is elapsed and a redemption result of the fund is notified to the automobile sales server.

### TECHNICAL FIELD

The present invention relates to a system and a method for selling a real asset in association with a financial product, and more particularly, to a system and a method for selling a real asset in association with a financial product in which a purchase price of the real asset deposited by a customer is invested in a fund having a standard index during a predetermined period so that the customer can raise an extra revenue in addition to obtaining the real asset and a seller can earn a profit from increase in sales of the real asset even if a part of investment activity incurs a loss.

### BACKGROUND ART

In a typical automobile sales transaction, a buyer directly visits a car dealership to inspect and examine a car and a seller delivers the car to the buyer within a certain time period after the price of the car is paid.

However, it is beneficial for a car manufacturer to reduce a car buying cycle of the buyer so that car sales can be increased, thereby earning more profit. Therefore, various techniques to induce purchase are suggested.

For example, price cutting is most effective in inducing the purchase and directly affects the car sales. However, if the price cut is too small, increase in sales is insignificant, and if the price cut is too drastic, not enough profit is generated.

Therefore, there is a need for a car sales method that provides a win-win solution to both customers and car manufacturers.

### DISCLOSURE OF INVENTION

### Technical Problem

The present invention has been made in view of the above problems, and provides a system and a method for selling a real asset in association with a financial product in which a real asset (e.g., a junk car) of a customer is delivered, a purchase price of a real asset (e.g., a new car) deposited by a customer is invested in a fund having a standard index during a predetermined period, and the real asset is provided to the customer with or without a profit depending on an investment result so that the customer can raise an extra revenue in addition to obtaining the real asset and a seller can earn a profit from increase in sales of the real asset even if a part of investment activity incurs a loss.

In the present invention, the financial product includes financial funds and raw materials funds, and the real asset includes real properties such as, for example, land real estates, commercial buildings, apartments as well as gold, vehicles, electronic products, and raw materials.

### Solution to Problem

In accordance with one aspect of the present invention, provided is a system for selling a real asset in association with a financial product, the system comprising: an automobile sales server configured to determine investment money as a purchase price of a new car to be purchased by a customer, configured to determine a loss ratio of the investment money based on a value of a junk car to be delivered by the customer, and configured to transmit the determined investment money and the loss ratio along with customer information to a fund subscription server; the fund subscription server configured to subscribe the customer to a particular fund if the customer is a permitted customer of the automobile sales server; and a fund management server configured to manage the particular fund in connection with the fund subscription server, wherein the particular fund is redeemed when a loss of the investment money of the customer exceeds the loss ratio or a predetermined fund operation period is elapsed, and a redemption result of the particular fund is notified to the automobile sales server.

In accordance with another aspect of the present invention, provided is a method of selling a real asset in association with a financial product, the method comprising: determining, by an automobile sales server, an investment money as a price of a new car to be purchased by a customer and determining a loss ratio of the investment money based on a value of a junk car to be delivered by the customer; transmitting the determined investment money and the loss ratio along with customer information to a fund subscription server; subscribing, by the fund subscription server, the customer to a particular fund if the customer is a permitted customer of the automobile sales server and the corresponding customer requests for fund subscription; and managing, by a fund management server, the particular fund in connection with the fund subscription server, and notifying, when the particular fund is redeemed because a loss of the investment money of the customer exceeds the loss ratio or a predetermined fund operation period is lapsed, a redemption result of the particular fund to the automobile sales server.

### Advantageous Effects of Invention

As described above, the customer can raise an extra revenue in addition to gaining the real asset while the seller of the real asset can earn a profit from an overall increase in sales of the real asset even if part of investment activity incurs a loss.

### BRIEF DESCRIPTION OF DRAWINGS

The objects, features and advantages of the present invention will be more apparent from the following detailed description in conjunction with the accompanying drawings, in which:

FIG. 1 illustrates a configuration of a real asset sales system associated with a financial product according to an exemplary embodiment of the present invention;

FIG. 2 illustrates a detailed configuration of an automobile sales server according to an exemplary embodiment of the present invention;

FIG. 3 illustrates a detailed configuration of a fund subscription server according to an exemplary embodiment of the present invention;

FIG. 4 illustrates a detailed configuration of a fund management server according to an exemplary embodiment of the present invention; and

FIG. 5 illustrates a detailed configuration of a fund operation server according to an exemplary embodiment of the present invention; and

FIG. 6 is a flow chart illustrating a real asset sales method associated with a financial product according to an exemplary embodiment of the present invention.

### BEST MODE FOR CARRYING OUT THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In the present invention, the term “junk car” refers to a vehicle, e.g., a used vehicle, owned by a customer who wants to buy a new car.

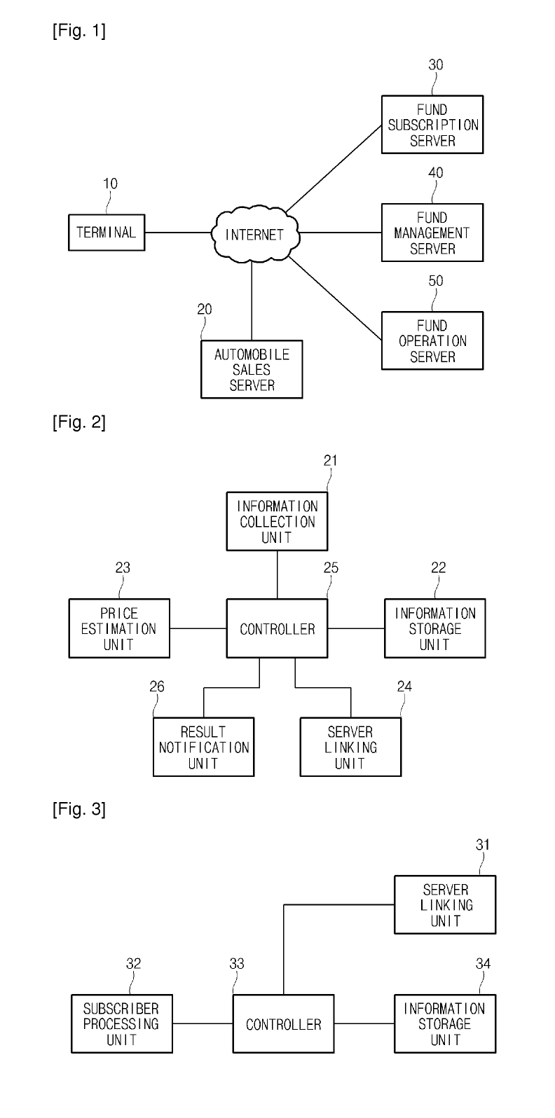

FIG. 1 illustrates a configuration of a real asset sales system associated with a financial product according to an exemplary embodiment of the present invention. In this embodiment, it is assumed that the real asset is, for example, an automobile.

As shown in FIG. 1, the real asset sales system associated with the financial product includes a terminal 10, a automobile sales server 20, a fund subscription server 30, a fund management server 40, and a fund operation server 50.

Hereinafter, each element is described in more detail. First, the terminal 10 is preferably a terminal that is used in a car dealership and is registered with the automobile sales server 20. The terminal 10 can include a smart phone or a personal computer (PC).

The automobile sales server 20 receives a promise from a customer to deliver a junk car through the terminal 10, estimates a price of the junk car based on customer information, junk car information, and new car information, and determine a loss ratio according to the estimated price of the junk car. Also, the automobile sales server 20 determines investment money as a price of the new car the customer wants to buy. Here, the new car information includes a model of the new car the customer wants to buy and an engine displacement thereof and the automobile sales server 20 stores price information of the car according to the model and the engine displacement thereof.

In addition, the automobile sales server 20 transmits loss ratio information determined by the price of the junk car of the customer, investment money information and the customer information to the fund subscription server 30.

In addition, when a notice of investment termination for a particular customer is received from the fund management server 40, the automobile sales server 20 notifies the particular customer of an investment result. When positive returns occur, profit amount information along with a new vehicle delivery date is notified to the customer. When negative returns occur, the customer is notified that no profit is earned due to the loss of investment and the new vehicle will be delivered without requiring a further payment as agreed in a contract as well as notified of the new car delivery date. Here, in order to notify the customer, an e-mail can be sent to the customer or a sales representative who receives an e-mail notification can call the customer or show the customer corresponding information displayed on a screen of the terminal 10.

Meanwhile, the fund subscription server 30, which is preferably a brokerage server, purchases a particular fund on behalf of the customer authorized to purchase the fund by the automobile sales server 20.

In other words, upon receiving the loss ratio information, the customer information, and the investment money information from the automobile sales server 20, the fund subscription server 30 allows the corresponding customer to purchase the particular fund.

Thus, the fund subscription server 30 sells the particular fund pre-agreed with the automobile sales server 20 to the customer under certain conditions.

Meanwhile, the fund management server 40, which is preferably a banking server, manages the fund in connection with the fund subscription server 30 and the fund operation server 50.

Namely, the fund management server 40, in connection with the fund subscription server 30, obtains the customer information, the loss ratio information, and the investment money information and manages the fund according to a fund management instruction, e.g., fund sales, received from the fund operation server 50.

In addition, when a loss on the investment money of the customer incurs in excess of a predefined loss ratio or a predefined time period of fund operation is passed, the fund management server 40 redeems the fund and notifies a result of redemption to the automobile sales server 20.

Meanwhile, the fund operation server 50, which is an asset management server, transmits the fund management instruction received from a fund manager to the fund management server 40 to sunstantially operate the fund.

Below, with reference to FIG. 2, the automobile sales server 20 is described in more detail.

As shown in FIG. 2, the automobile sales server 20 according to the present invention includes an information collection unit 21, an information storage unit 22, a price estimation unit 23, a server linking unit 24, a controller 25, and a result notification unit 26.

First, when the terminal 10 is connected to the information collection unit 21, the information collection unit 21 performs a predetermined authentication process and provides the authenticated terminal 10 with a screen having a customer information input window, a junk car information input window, and a new car information input window. Here, the authentication process is performed in a secured manner by using, for example, a public key certificate or a general purpose certificate. The customer information input window, the junk car information input window, and the new car information input window can be provided to the terminal 10 in separate windows or in the same window.

In addition, before providing the new car information input window to the terminal 10, the information collection unit 21 can provide specifications and price information of each car to assist the customer in selecting the car. In case the terminal 10 is used in the car dealership store, the customer can obtain detailed descriptions of cars from a salesperson, and thus, the specification and the price information provided by the information collection unit 21 can be a secondary assistance. In case the terminal 10 is a personal terminal of the customer, the specification and the price information can be a substantial assistance.

In addition, the information collection unit 21 receives a customer's name, social security number, address, phone number, or email address through the customer information input window provided to the terminal 10. Namely, the customer enters personal information in each field of the customer information input window displayed on the screen of the terminal 10.

In addition, the information collection unit 21 receives a model, engine displacement, year, mileage, or accident history of the car owned by the customer through the junk car information input window provided to the terminal 10 so that the automobile sales server 20 can determine the price of the junk car. Namely, the customer enters information of his or her vehicle in each field of the junk car information input window displayed on the screen of the terminal 10. Here, the customer enters the junk car information with intent to deliver his or her junk car to the automobile sales server 20.

In addition, the information collection unit 21 receives information of the car the customer wants to purchase through the new car information input window provided to the terminal 10. Namely, the customer enters the new car information such as, for example, the model and engine displacement of the new car to be purchased in the new car information input window displayed on the screen of the terminal 10.

In the above, it is described that the customer directly enters the customer information, the junk car information and the new car information; however, it should be noted that the customer can provide information by a written document or orally so that the salesperson at the car dealership store enters such information.

Additionally, the information collection unit 21 can provide an input window to the terminal 10 to verify whether the customer agrees to invest in the fund in accordance with the present invention.

Meanwhile, the information storage unit 22 stores a standard index of a default loss ratio (e.g., 5%) of the investment money, which is the estimated price of the junk car (e.g., 300 dollars) and also stores a loss ratio table in which the default loss ratio increases in proportional to the price of the junk car. For example, in the loss ratio table, if the price of the junk car is a default price, the loss ratio is set as 5% and the loss ratio is increased at a certain rate as the price of the junk car increases at a certain rate. Here, when the loss ratio is increased, more benefits can be offered to the customer.

The price estimation unit 23 estimates the price of the junk car based on the junk car information, which is collected by the information collection unit 21 and provided through the controller 25. In other words, the price estimation unit 23 estimates the price of the junk car by using a price table stored therein. For example, the price table can be created by reducing a default price of the car according to the year of the car by a certain percentage while additional reduction can be added depending on the mileage or the accident history. Here, the certain percentage in reduction can vary depending on the model and the engine displacement of the vehicle.

Also, in order to obtain a more accurate estimation of the price of the junk car, the price estimation unit 23 can be linked with a terminal of a used car dealership so that a used car dealer can inspect the junk car and enters the estimated price of the junk car.

The server linking unit 24 is linked with the fund subscription server 30 and the fund management server 40 to transmit and receive various information therebetween.

The controller 25 determines the loss ratio in correspondence with the price of the junk car estimated by the price estimation unit 23, based on the loss ratio table stored in the information storage unit 22.

Also, the controller 25 is linked with the fund subscription server 30 through the server linking unit 24 to provide the personal information, the investment money (i.e., the price of the new car) information and the loss ratio information of the customer to which fund subscription is permitted.

Here, an operator of the automobile sales server 20 enters into an agreement with an operator of the fund subscription server 30 in advance with respect to a type of the fund to be subscribed by the customer who is authorized by the automobile sales server 20. A fixed time period during which the fund is to be managed is determined for each customer. Here, the number of the funds that are available for subscription by the customer is preferably one or more, and when multiple funds are available, the customer can choose the fund to subscribe.

In addition, when the controller 25 receives a notice to terminate investment of a particular customer from the fund management server 40 through the server linking unit 24, the controller 25 controls the result notification unit 26 to notify the corresponding customer of the investment result along with the new vehicle delivery date.

In notifying the corresponding customer of the investment result in response to the notice of the investment termination received from the controller 25, when the investment incurs positive returns, the result notification unit 26 informs the customer of the profit amount information along with the new vehicle delivery date. When the investment incurs negative returns, the result notification unit 26 informs that no profit is earned due to the incurred loss in the investment and the new car will be delivered without requiring any further payment as agreed in the contract and informs of the new vehicle delivery date.

Hereinafter, with reference to FIG. 3, the fund subscription server 30 is further described in more detail.

As shown in FIG. 3, the fund subscription server 30 according to the present invention includes a server linking unit 31, a subscriber processing unit 32, a controller 33, and an information storage unit 34.

First, the server linking unit 31, in connection with the automobile sales server 20, receives the customer information, the loss ratio information and the investment money information. Namely, the server linking unit 31 receives the personal information, the loss ratio information, and the investment money information of a particular customer from the automobile sales server 20.

Also, the server linking unit 31 shares the customer information, the loss ratio information, and the investment money information that are received in connection with the automobile sales server 20 with the fund management server 40.

When the terminal 10 is connected to the subscriber processing unit 32, the subscriber processing unit 32 performs a predetermined authentication process and provides the authenticated terminal 10 with fund subscription agreement information and an information input screen for fund subscription. Here, the server linking unit 31 shares fund subscription information of the customer obtained through the subscriber processing unit 32 with the fund management server 40.

The controller 33 stores the customer information, the loss ratio information and the investment money information obtained by the server linking unit 31 in the information storage unit 34.

In addition, the controller 33 stores the fund subscription information obtained through the subscriber processing unit 32 in the information storage unit 34.

In addition, the controller 33 determines whether the customer who requests to subscribe to the fund through the subscriber processing unit 32 is permitted to subscribe to the fund by using the customer information stored in the information storage unit 34. Based on the determination, the controller 32 subscribes only the permitted customer to the fund.

The information storage unit 34, under the control of the controller 33, stores the customer information, the loss ratio information and the investment money information that are matched with the fund subscription information. Here, the fund subscription information can include, for example, a name of the subscribed customer, a subscription date, a date of fund redemption, and a name of the fund.

Additionally, the information storage unit 34 stores financial fund product information such as, for example, a trust asset management method, a redemption fee calculation method, a trust fee calculation method, an accounting period and a repurchase method.

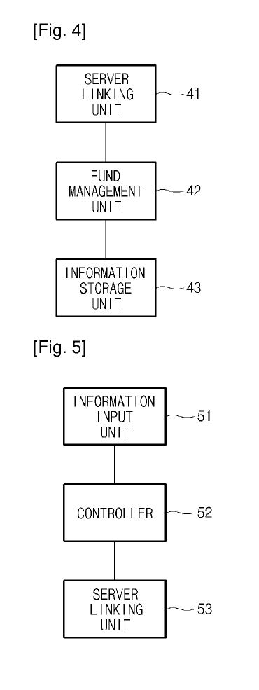

Hereinafter, with reference to FIG. 4, the fund management server 40 is described in more detail.

As shown in FIG. 4, the fund management server 40 according to the present invention includes a server linking unit 41, a fund management unit 42, and an information storage unit 43.

First, the server linking unit 41, in connection with the fund subscription server 30, obtains the customer information, the loss ratio information, the investment money information and the fund subscription information.

In addition, the server linking unit 41 receives the fund management instruction, e.g., fund sales, from the fund operation server 50.

The fund management unit 42 manages the fund in accordance with the fund management instruction from the fund operation server 50 and stores updated information generated when operating the fund in the information storage unit 43.

The fund management 42 monitors the fund operating period set for each customer and, when the fund operating period is passed, redeems the fund and calculates a profit or loss to report to the automobile sales server 20.

The Fund management unit 42 identifies the loss ratio set for each customer and, if the loss of the investment money meets the corresponding loss ratio, sells the fund and report the sale to the automobile sales server 20.

Hereinafter, with reference to FIG. 5, the fund operation server 50 is described in more detail.

As shown in FIG. 5, the fund operation server 50 according to the present invention includes an information input unit 51, a controller 52, and a server linking unit 53.

First, the information input unit 51 receives the fund management instruction from a fund manager.

The controller 52 provides the fund management instruction inputted through the information input unit 51 to the server linking unit 53.

The server linking unit 53 transmits the fund management instruction provided from the controller 52 to the fund management server 40.

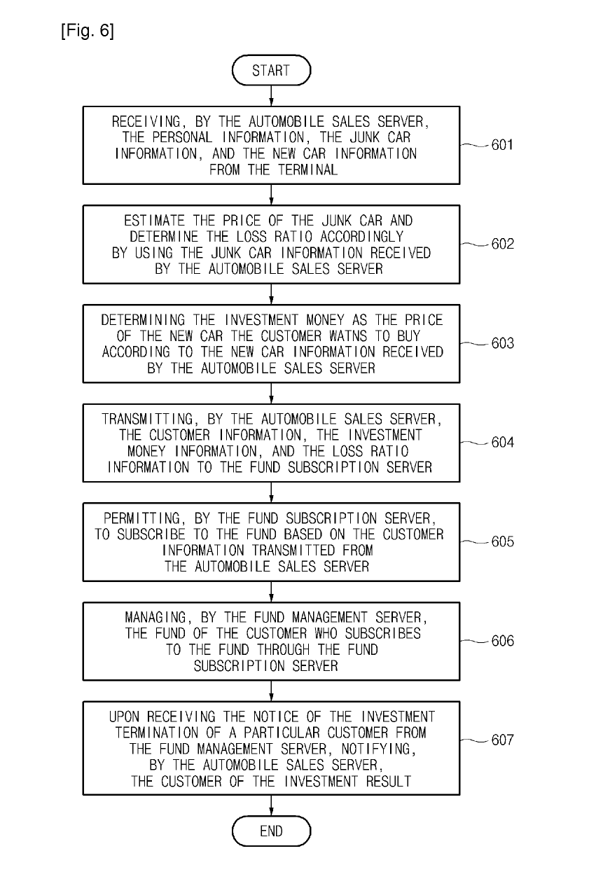

FIG. 6 is a flow chart illustrating a real asset sales method associated with a financial product according to an exemplary embodiment of the present invention.

First, the automobile sales server 20 receives the personal information, the junk car information, and the new car information from the terminal 10 (601). Namely, the customer enters his or her personal information, information of the junk car owned by the customer and information of the new car the customer wants to buy through the terminal 10.

Next, by using the junk car information received by the automobile sales server 20, the price of the junk car is estimated and the loss ratio is determined accordingly (602).

Next, the investment money is determined as the price of the new car the customer wants to buy according to the new car information received by the automobile sales server 20 (603).

Next, the automobile sales server 20 transmits to the fund subscription server 30 the customer information, the investment money information, and the loss ratio information determined according to the price of the junk car of the customer (604).

Next, the fund subscription server 20 permits the customer to subscribe to the fund based on the customer information transmitted from the automobile sales server 20 (605).

Next, the fund management server 40 manages the fund of the customer who subscribes to the fund through the fund subscription server 20 and, when the loss of the investment money of the customer exceeds a corresponding loss ratio or a predefined operation time period is passed, sells the fund and notifies the result to automobile sales server 20 (606).

Next, the automobile sales server 20, upon receiving the notice of the investment termination of a particular customer from the fund management server 40, notifies the customer of the investment result. When positive returns occur, the automobile sales server informs the profit amount information along with the new vehicle delivery date. When negative returns occur, it is informed that no profit is earned due to the loss of investment and the new car will be delivered without requiring any further payment as agreed in the contract as well as the new car delivery date is informed (607).

In the above described method, the customer can raise an extra revenue in addition to gaining the real asset while the seller of the real asset can earn a profit from an overall increase in sales of the real asset even if part of investment activity incurs a loss.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

1. A system for selling a real asset in association with a financial product, the system comprising:
an automobile sales server configured to determine investment money as a purchase price of a new car to be purchased by a customer, configured to determine a loss ratio of the investment money based on a value of a junk car to be delivered by the customer, and configured to transmit the determined investment money and the loss ratio along with customer information to a fund subscription server;
the fund subscription server configured to subscribe the customer to a particular fund if the customer is a permitted customer of the automobile sales server; and
a fund management server configured to manage the particular fund in connection with the fund subscription server, wherein the particular fund is redeemed when a loss of the investment money of the customer exceeds the loss ratio or a predetermined fund operation period is elapsed, and a redemption result of the particular fund is notified to the automobile sales server.

2. The system according to claim 1, wherein, upon receiving a notice of termination of the customer's investment from the fund management server, the automobile sales server is configured to notify the corresponding customer of an investment result along with a delivery date of the new car, wherein, when a positive return is generated, the delivery date of the new car is notified with information of a profit amount, and, when a negative return is generated, the delivery date of the new car is notified with a statement that no profit is payable due to a loss of the investment and the new car is to be delivered without a further payment, as agreed in a contract.

3. The system according to claim 2, wherein the particular fund is a fund that is pre-agreed between the automobile sales server and the fund subscription server.

4. The system according to claim 2, further comprising:
a fund operation server configured to operate the particular fund managed by the fund management server.

5. The system according to claim 2, wherein the automobile sales server is configured to sell the new car on a condition that the junk car owned by the customer is traded in.

6. The system according to claim 2, wherein the automobile sales server is configured to estimate a price of the junk car by using at least one of, a model, an engine displacement, a year, a mileage, or an accident history of the junk car, and configured to determine the loss ratio based on the estimated price of the junk car.

7. The system according to claim 2, wherein the automobile sales server comprises:
an information collection unit configured to perform a predetermined authentication process when a terminal is connected thereto and configured to provide an authenticated terminal with an input screen having a customer information input window, a junk car information input window, and a new car information input window to receive the customer information, junk car information, and new car information;
an information storage unit configured to store a loss ratio table in which a default loss ratio is increased in proportional to a price of the junk car;
a price estimation unit configured to estimate the price of the junk car based on the junk car information collected by the information collection unit;
a server linking unit configured to link the fund subscription server with the fund management server;
a controller configured to determine the loss ratio in correspondence with the price of the junk car estimated by the price estimation unit based on the loss ratio table, configured to transmit the loss ratio, the investment money determined according to the new car information, and the customer information to the fund subscription server, and configured to control a result notification unit to notify the corresponding customer of the investment result upon receiving the notice of the termination of the customer's investment from the fund management server; and
the result notification unit configured to notify the investment result in accordance with a control of the controller.

8. The system according to claim 7, wherein the information collection unit is configured to provide an input window to the terminal to verify whether the customer agrees to invest in the particular fund.

9. The system according to claim 7, wherein the controller is configured to control the result notification unit to notify, when the positive return is generated, the delivery date of the new car along with the information of the profit amount, and is configured to notify, when the negative return is generated, the delivery date of the new car with the statement that no profit is payable due to the loss of the investment and the new car is to be delivered without further payment as agreed in the contract.

10. The system according to claim 2, wherein the fund subscription server is configured to permit the customer to subscribe to the particular fund when the customer information, loss ratio information, and investment money information are received from the automobile sales server.

11. The system according to claim 2, wherein the fund subscription server comprises:
a subscriber processing unit configured to perform a predetermined authentication process when a terminal is connected thereto and configured to provide an authenticated terminal with fund subscription agreement information and an information input screen for fund sub- scription;
a server linking unit configured to share, with the fund management server, the customer information, loss ratio information, and investment money information that are received in connection with the automobile sales server and fund subscription information of the customer obtained through the subscriber processing unit;
a controller configured to permit the customer to subscribe to the fund based on the customer information; and
an information storage unit configured to, under the control of the controller, store the customer information, the loss ratio information and the investment money information that are matched with the fund subscription information.

12. The system according to claim 2, wherein the fund management server comprises:
a server linking unit configured to obtain the customer information, loss ratio information, investment money information and fund subscription information in connection with the fund subscription server; and
a fund management unit configured to redeem the fund when the predetermined fund operation period of the customer is lapsed or the loss of the investment money of the customer exceeds the predetermined loss ratio and configured to calculate a profit or a loss ratio of the investment to be sent to the automobile sales server.

13. A method of selling a real asset in association with a financial product, the method comprising:
determining, by an automobile sales server, an investment money as a price of a new car to be purchased by a customer and determining a loss ratio of the investment money based on a value of a junk car to be delivered by the customer;
transmitting the determined investment money and the loss ratio along with customer information to a fund subscription server;
subscribing, by the fund subscription server, the customer to a particular fund if the customer is a permitted customer of the automobile sales server and the corresponding customer requests for fund subscription; and
managing, by a fund management server, the particular fund in connection with the fund subscription server, and notifying, when the particular fund is redeemed because a loss of the investment money of the customer exceeds the loss ratio or a predetermined fund operation period is lapsed, a redemption result of the particular fund to the automobile sales server.

14. The method according to claim 13, wherein the determining comprises:
receiving, by the automobile sales server, the customer information, junk car information and new car information from the terminal;
estimating a price of the junk car by using the junk car information received by the automobile sales server and determining the loss ratio accordingly; and
determining the investment money as the price of the new car to be purchased by the customer based on the new car information received by the automobile sales server.

15. The method according to claim 13, wherein the determining comprises:
estimating a price of the junk car by using at least one of, a model, an engine displacement, a year, a mileage, or an accident history of the junk car, wherein the loss ratio is determined based on the estimated price of the junk car.

16. The method according to claim 13, wherein the notifying comprises:
notifying, when a positive return is generated, information of a profit amount along with a delivery date of the new car; and
notifying, when a negative return is generated, a statement that no profit is payable due to a loss of investment and a new car is to be delivered without a further payment as agreed in a contract along with the delivery date of the new car.
